(19) United States
(12) Patent Application Publication
(10) Pub. No.: US 2008/0235612 A1
(43) Pub. Date: Sep. 25, 2008

(54) User Interface Control Program and Method for Controlling User Interface

(75) Inventor: Tomohiro NAKAGAWA, Matsumoto-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/050,804

(22) Filed: Mar. 18, 2008

(30) Foreign Application Priority Data
Mar. 22, 2007 (JP) 2007-075241

(51) Int. Cl. G06F 3/048

(52) U.S. Cl. 715/772

(57) ABSTRACT

There is provided a user interface control program by which a process for controlling a user interface in a computer equipped with a control device and a display device is performed by the control device. The process performed by the user interface control program includes displaying a graphic interface of a slider type for instructing a predetermined performance in which a state of a predetermined index which continuously changes is specified on the display device, when a position except an end of the graphic interface is instructed, instructing the predetermined performance in which a state of the predetermined index corresponding to the instructed position is specified, and when a position of an end of the graphic interface is instructed, instructing a performance different from the predetermined performance.

### CROSS-REFERENCE TO RELATED APPLICATIONS

This application is based upon and claims the benefit of priority from the prior Japanese Patent Application No. 2007-075241, filed on Mar. 22, 2007, the entire contents of which are incorporated herein by reference.

### BACKGROUND

1. Technical Field

The present invention relates to a program or the like for controlling a GUI (graphical user interface) of an application used for a computer, and in particular, to an user interface control program or the like capable of performing a plurality of operations for which interfaces as discrete means are conventionally prepared and which makes it possible to improve operability.

2. Related Art

In recent years, computers and various applications operated therein have been dramatically spread. In addition, various GUI's used for the applications has been developed. For example, there is a GUI so called a button as a general application. The user can perform a specific instruction assigned to the button, for example, an instruction for switching display or the like by clicking the button by a mouse.

Further, there is a GUI called as a slider. The slider is sort of like a knob operated by a mouse. A state of a specific index, for example, sound volume, brightness of display, or the like which continuously changes can be instructed by sliding the knob in the right and left direction or up and down direction.

For example, when a plurality of data, for example, a plurality of files stored in a personal computer or the like are displayed, switching of display when the attribute information of the plurality of data (file) is displayed by a list format as character information and when reduced images of the plurality of data (file), so called thumbnail display, are displayed is performed by a GUI of the button type described above. On the other hand, the enlargement and reduction of display image when a thumbnail is displayed is performed by a GUI of the above described slider.

Further, a technique for displaying a reduced image by using a scroll bar is proposed in JP-A-8-235200.

However, when a plurality of relevant instructions are performed, it is required that the user appropriately selects a plurality of buttons and sliders to which the instructions are assigned in the convention GUI described above. Accordingly, there is a case that the operability is bad.

For example, in the above described example when the information of a plurality of data is displayed, it is assumed that a desired data (file) is selected after a list format display and a thumbnail display are repeated for several times, and the whole display of the data is displayed. In this case, the user is required to appropriately select and operate a plurality of interfaces separately prepared such as a button for switching the display, a slider for displaying a thumbnail, a button for displaying the whole image, and the like.

### SUMMARY

An advantage of some aspects of the invention is to provide an user interface control program or the like which is a program for controlling a GUI of an application used in a computer, which can perform a plurality of operations for which an interface is conventionally prepared as discrete means by a sequence performance, and which can improve operability.

According to an aspect of the invention, there is provided a user interface control program by which a process for controlling a user interface in a computer equipped with a control device and a display device is performed by the control device. The process performed by the user interface control program includes displaying a graphic interface of a slider type for instructing a predetermined performance in which a state of a predetermined index which continuously changes is specified on the display device, when a position except an end of the graphic interface is instructed, instructing the predetermined performance in which a state of the predetermined index corresponding to the instructed position is specified, and when a position of an end of the graphic interface is instructed, instructing a performance different from the predetermined performance.

Further, it is preferable that a performance instructed when a position of one end of the graphic interface is instructed is different from a performance instructed when a position of the other end of the graphic interface is instructed in the above aspect of the invention.

Further, it is preferable that an icon for indicating a performance to be instructed when a position of an end is instructed is displayed at the vicinity of the end of the graphic interface in the above aspect of the invention.

Further, it is preferable that when the icon is instructed, a performance indicated by the icon is instructed in the above aspect of the invention.

Further, it is preferable that the user interface is used for displaying information about a plurality of data on the display device, when a position except the ends of the graphic interface is instructed, display of images about the plurality of data to which an enlargement factor in accordance with the instructed position is specified is instructed, when a position one end of the graphic interface is instructed, display of character information related to the plurality of data is instructed, and when a position of the other end of the graphic interface is instructed, display of an image about predetermined data selected from the plurality of data is instructed in the above aspect of the invention.

According to another aspect of the invention, there is provided a user interface control method for controlling a user interface in a computer equipped with a control device and a display device. The user interface control method performed by the control device includes displaying a graphic interface of a slider type for instructing a predetermined performance in which a state of a predetermined index which continuously changes is specified on the display device, when a position except an end of the graphic interface is instructed, instructing the predetermined performance in which a state of the predetermined index corresponding to the instructed position is specified, and when a position of an end of the graphic interface is instructed, instructing a performance different from the predetermined performance.

A further object and feature of the invention will be apparent from the embodiment of the invention described below.

### BRIEF DESCRIPTION OF THE DRAWINGS

The invention will be described with reference to the accompanying drawings, wherein like numbers reference like elements.

FIG. 1 is a diagram showing a structure of a print server equipped with a user interface control program to which the invention is applied according to an embodiment.

FIG. 2 is a flow chart exemplifying a process procedure of a display processing performed by a display control unit.

FIG. 3 is a diagram exemplifying a view display window for displaying each view and a slider.

### DESCRIPTION OF EXEMPLARY EMBODIMENTS

Hereinafter, an embodiment of the invention will be described with reference to the accompanying drawings. However, the embodiment does not restrict the technical scope of the invention. Note that, the same reference numeral or the same reference symbol is used to denote the same or similar element in the drawings.

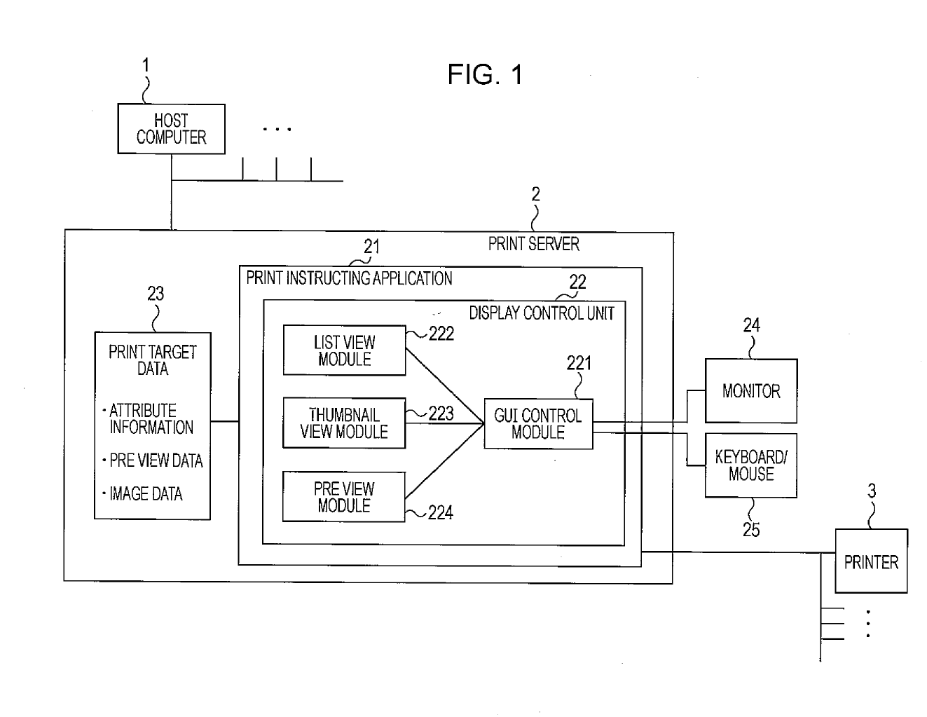

FIG. 1 is a diagram showing a structure of a print server equipped with a user interface control program to which the invention is applied according to the embodiment. The print server 2 shown in FIG. 1 is a print server according to the embodiment. The print server 2 prepares a slider type interface as a GUI when the user selects desired data among plurality of stored print target data 23 to perform print instruction, and enables to instruct displaying a list at the left end of the slider bar type interface, to instruct displaying a thumbnail at an enlargement factor corresponding to the position at a midstream position of the slider bar type interface, and to instruct displaying the hole of the selected data at the right end of the slider bar type interface. Herewith, a plurality of relevant operations can be performed by a sequence performance, thereby improving the operability.

The print server 2 according to the embodiment is an example of a computer equipped with an application utilizing the user interface control program of the invention and a server specialized for print function connected to not less than one host computer 1 and not less than one printer 3. The print server 2 may be constituted by a personal computer or the like, and mainly has functions such as relay of print processing, process of print data (converting print data to bitmap data, or the like), accumulation of processed print data (accumulation of print data converted to bitmap data), and the like. When a print job is receive from the host computer 1, the print server 2 interprets the PDL to create data suited for the printer 3 of the required print destination, and transmits the created data to the printer 3.

Further, the print server 2 can create data suited for the printer 3 of a print required destination as for accumulated bit map data when a print requiring instruction is received from the user to transfer the created data to the printer 3. When a print requiring instruction is received from the user, the print server 2 can receive instruction of print settings from the user, and plays a function to create data in accordance with the print settings instructed from the user to transfer the created data to the printer 3.

As shown in FIG. 1, the print server 2 is equipped with a print instructing application 21 and capable of storing the print target data 23. Note that, in FIG. 1, the structure of the print server 2 is functionally shown. The print server 2 is equipped with a control device such as a CPU, a data recording device such as a, ROM, RAM, HDD, and the like, although not shown in FIG. 1. The print server 2 is also equipped with a plurality of applications for controlling each function in addition to described above the print instructing application 21.

The print instructing application 21 is stored in the HDD or the like in the print server 2, and the CPU executes the processing according to the program of the print instructing application 21.

The print instructing application 21 is an application for receiving a print instruction from the user with respect to the print target data 23 stored in the print server 2 to create the data suited for the printer 3 as for the print target data 23 instructed by the user, thereby performing a print instruction by transferring the created data to the printer 3.

As shown in FIG. 1, the print instructing application 21 includes a display control unit 22. The display control unit 22 is a part which controls a function for showing the print target data 23 stored in the print server 2 to the user at a plurality of display modes in order to determine the print target data 23 to which the above print instruction is performed by the user. Specifically, a list view by which each print target data 23 is displayed by a list form, a thumbnail view by which a reduced image of each print target data 23 is displayed, and a preview by which the hole image of the selected print target data 23 is displayed are switched and displayed based on the instruction (operation) from the user.

As shown in FIG. 1, the display control unit 22 includes a GUI control module 221, a list view module 222, a thumbnail module 223, and a preview module 224. The GUI control module 221 is a part for controlling the GUI for displaying the above print target data 23 and for switching the data. The GUI control module 221 displays a display window for displaying the above each view and an operation interface of a slider type for switching the display on an monitor 24, receives an instruction by an operation by the user with respect to the above described operation interface using a keyboard/mouse 25, and creates a view in accordance with the instruction to perform processing for display the view in the above described display window. A significant characteristic exists in the above described operation interface of a slider type provided by the GUI control module 221, but the specific content thereof will be described below.

Next, the list view module 222, the thumbnail module 223, and the preview module 224 are portions for respectively taking out necessary data for creating a list view, a thumbnail view, or a preview in accordance with the requirement from the GUI control module 221 to provide the data to the GUI control module 221.

Note that, each module included in the display control unit 22 is constituted by each program in which a process procedure for providing each function is written, a control device such as a CPU equipped in the print server 2 for performing a process in accordance with the program, and the like. Further, in addition to the display control unit 22, another module for performing the above described function exists in the print instructing application 21 although omitted in FIG. 1.

Next, the print target data 23 is a data group which is a target of printing instructed by the print instructing application 21 and is stored in a HDD (not shown) or the like of the print server 2. Each print target data is constituted by a unit such as one print job from the host computer 1, one image data of a photograph or the like, and each has attribute information, preview data, and image data linked by identification information. Herein, the image data is the data of image which becomes a target of printing and stored as, for example, bitmap data. The attribute information is information of attribution of the image data related to a capacity, data format, creator, or the like of the data. Further, the preview data is data for displaying an image which becomes a target of printing on the monitor 24 and is data in which the size of the image data is reduced.

Further, the monitor 24 is a display device of the print server 2 and the keyboard/mouse 25 is an input device of the print server 2.

The print server 2 according to the embodiment has the structure as described above. Hereinafter, the process, in particular, the process for switching the views described above when print instruction is performed from the print server 2 will be specifically described.

When print instruction is performed, first, the user activates the print instructing application 21 by using the keyboard/mouse 25. When the print instructing application 21 is activated, the display control unit 22 displays the above described view display window and the operation interface for switching the views on the monitor 24. The user appropriately changes the views and selects the print target data 23 to be printed and output by using the interface. Note that the interface and specific process contents about the display of the views will be described below.

Then, the user operates the interface for instruction such as a print instructing button displayed on the monitor 24 to perform instruction of printing. When the instruction is received, the print instructing application 21 creates data for the printer 3 as for the selected print target data to transfer the created data to the printer 3. The printer 3 receives the data to perform print processing in accordance with the data and output the print target data 23 instructed by the user on a print medium.

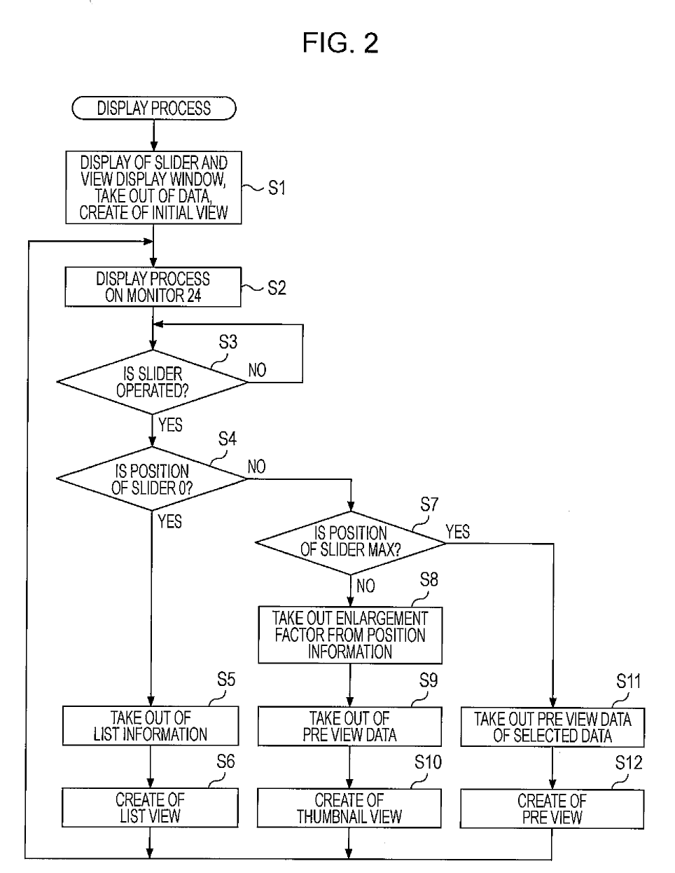

In this manner, print instruction is performed as for the print target data 23 stored in the print server 2. Hereinafter, display processing of the print target data 23 which is a characteristic of the print server 2 will be specifically described. FIG. 2 is a flow chart for exemplifying a process procedure of the display processing performed by the display control unit 22.

As described above, when the print instructing application 21 is activated, the display control unit 22 displays the view display window and the operation interface for switching the view display on the monitor 24. Specifically, the GUI control module 221 takes out the data for displaying a slider which is the above described operation interface and the view display window from a predetermined storage portion and creates an initial view displayed in the view display window (step S1). As described above, a list view, a thumbnail view, or a preview can be displayed when the print target data 23 is displayed. In the embodiment, a view preliminarily set among the views, or the view which is lastly instructed in the previous process is created as an initial view. For example, a list view is generated as an initial view. Note that, the creation of each view and display procedure will be described below.

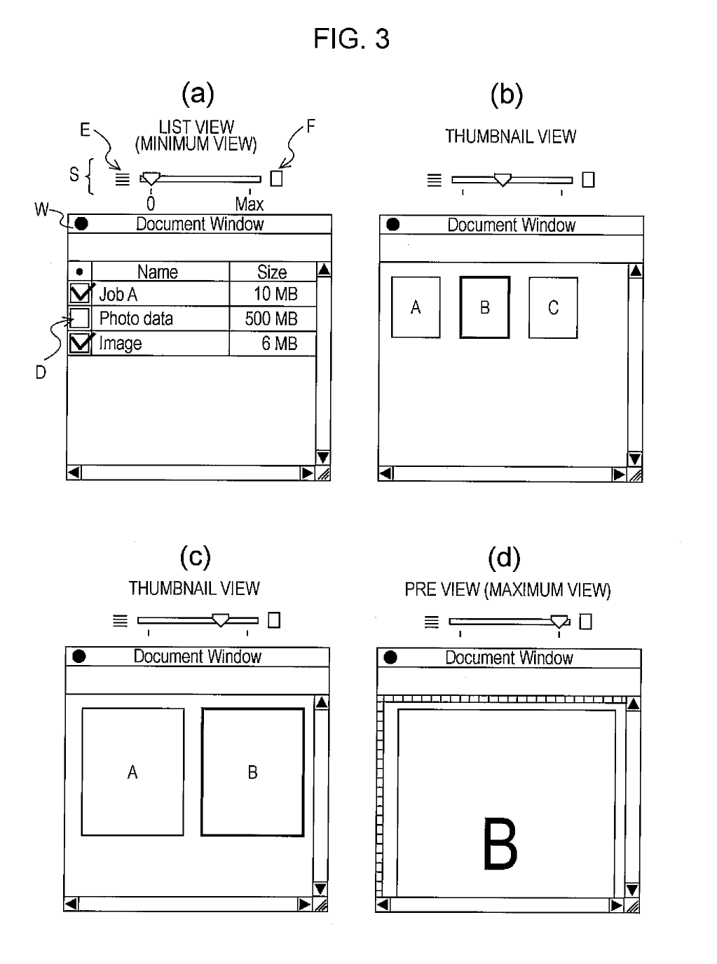

Next, the GUI control module 221 displays the slider and the view display window based on the taken out data on the monitor 24 and displays an initial view created in step S1 in the view display window (step S2). FIG. 3 is a diagram exemplifying the view display window for displaying each view and the slider. FIG. 3 (a) exemplifies the state displayed on the monitor 24 by the above process when the initial view is a list view. The portion shown by S in FIG. 3 is the slider and the window shown by W in FIG. 3 is the view display window.

As shown in FIG. 3, the slider S has the shape similar to the general slider, and is operated by sliding the knob having a pentagon shape right and left on the slider bar. However, the content of the performance instructed by the operation is different as the conventional one. Specifically, when the knob is moved to the left end, that is, moved to the position of “0” of FIG. 3 (a), it is instructed to display a list view of the print target data 23, and when the knob is moved to the right end, that is, moved to the position of “max” of FIG. 3 (a), it is instructed to display a preview of the selected print target data 23. Further, when the knob is moved to a position except the left end and the right end (position between “0” and “max” which does not include “0” and “max”), it is instructed to display a thumbnail view at the enlargement factor in accordance with the position. That is, in the present slider S, the function for continuously changing the enlargement factor of the thumbnail view originally suited for a slider is assigned to the position except the ends and a different view display, in other words, the view switching function originally suited for an interface of a button is assigned to the both ends.

Further, in other words, the above three views can be switched and displayed by moving the knob of the slider S to each position of the left end, right end, and intermediate portion, and the display is magnified as the position comes close to the right end in the intermediate portion.

In the view display window W of in FIG. 3 (a), as described above, a list view which is the initial view is displayed therein.

In this manner, when the initial state is displayed, the GUI control module 221 waits that the slider is operated by the user (step S3). When the slider is operated by using the keyboard/mouse 25 by the user, the GUI control module 221 takes out the position of the knob after operated.

Then, when the taken out position is “0” (Yes in step S4), the GUI control module 221 instructs the list view module 222 to take out the data for displaying a list view in order to display the list view. Note that when the initial view is set to a list view, the operation for setting the position of the slider to “0” is not performed by the user and the process for displaying the list view is not performed after the timing right after the initial view. However, when the operation for moving the position of the slider to “0” from a position of not “0” is performed, the process for displaying a list view is performed.

The list view module 222 received the above instruction reads out the above described attribute information of each print target data 23 to provide the attribute information to the GUI control module 221 (step S5). For example, the list view module 222 reads out the name and the data amount as for the whole data which can be a target of printing kept by the print server 2 to provide as the information for a list view.

Then, the GUI control module 221 creates the data of a list view from the above described taken out list information (step S6), and displays a list view on the monitor 24 based on the data (step S2). For example, the view shown in the view display window W of in FIG. 3 (a) is displayed. In this example, three print target data 23 are kept in the print server 2, and the name (“Name”) and the data amount (“Size”) thereof are shown by a list format. The user can see the attribute information of each data by the list information in order to select the data which is a target of printing.

Next, return to step S4, when the operated position of the slider is not “0” (left end) (No in step S4) and not “Max” (right end) (No in step S7), the GUI control module 21 performs the process described below in order to display a thumbnail view. First, the GUI control module 21 searches the enlargement factor when a thumbnail is display from the taken out position of the knob after operated (step S8).

Next, the GUI control module 21 instructs the thumbnail view module 223 to take out the preview data of each print target data 23. When the instruction is received, the thumbnail module 223 reads out preview data from a predetermined storage portion to provide the preview data to the GUI control module 221 (step S9).

The GUI control module 221 creates thumbnail data having the enlargement factor in accordance with the position of the knob from the preview data of the received each print target data 23 and the above searched enlargement factor (step S10). Then, The GUI control module 221 displays a thumbnail view on the monitor 24 based on the data (step S2).

For example, the view shown in the view display window of FIG. 3 (b) or FIG. 3 (c) is displayed. A reduced image which is a target of printing is displayed in the thumbnail view. Accordingly, in the example, images of miniature version are respectively displayed as for the three print target data 23 displayed in the list view (A, B, C in FIG. 3). In this regard, the enlargement factor of FIG. 3 (c) is larger than that of FIG. 3 (b) as the knob is positioned at the right side than FIG. 3 (b), so that only two print target data 23 (A, B) are displayed. Further, the display states of FIG. 3 (b) and FIG. 3 (c) are examples of the thumbnail view which can be continuously displayed at different enlargement factors. Accordingly, by moving the knob to another position, the user can display the thumbnail view at an enlargement factor different therefrom. The user can view output image of each data at various enlargement factors by such a thumbnail view in order to select the data which is a target of printing.

Next, return to step S7, when the operated position of the slider is “Max” (right end) (Yes in step S7), the GUI control module 221 performs a process for displaying a preview. Herein, as described above, a preview before performing printing is displayed as for the selected print target data 23 in the preview display. In the normal case, the operation for selecting one data from a plurality of print target data 23 is performed before the position of the knob is moved to “Max”. The selecting operation is performed by, for example, clicking the data to be selected by the mouse in the display screen of the above list view or thumbnail view. In the example of FIG. 3, the print target data 23 is selected by clicking the portion shown by D of FIG. 3 (a) and the print target data 23 is selected by clicking the image shown by “B” of (b). Note that, when the selecting operation is not performed, the print target data 23 to be selected can be determined based on a predetermined rule. For example, the print target data 23 displayed at the top of the list view should be selected.

First, the GUI control module instruct the preview module 224 to take out preview data of the above selected print target data 23 when the above operation of the slider is received. The preview module 224 reads out the preview data from a predetermined storage portion to provide the preview data to the GUI control module 221 (step S11).

The GUI control module 221 creates data for a preview from the received preview data of the print target data 23 (step S12). Then, the GUI control module 221 displays a preview on the monitor 24 based on the data (step S2). For example, the preview shown in FIG. 3 (d) is displayed. Herein, the print target data 23 of the image shown by “B” is selected and the preview is displayed for only “B”. The user can use the preview in order to determine the data which becomes a target of printing or in order to confirm the output state of the data which is a target of printing. Note that, the enlargement factor of the preview can be increased than the maximum enlargement factor of the thumbnail view.

In this manner, a view in accordance with the position of the knob is displayed for each time the slider is operated by the user.

As described above, by the process performed by the display control unit 22, a plurality of views of each print target data 23 can be viewed by using one interface, that is the slider, when the user determines the print target data 23 for instructing printing. Accordingly, it is not necessary to use discrete interface means as in the conventional way as for related different performances (instructions), and the operation can be executed as a sequence performance. Consequently, the operability can be improved.

Note that, as shown in FIG. 3, an icon which indicates a performance instructed when the knob is moved to the ends may be displayed at the vicinity of the ends of the slider S (E and F of in FIG. 3 (a)). In the example of FIG. 3, a list view is displayed at the left end, so that the icon E by which a list display is imaged is displayed at the side of the left end, a preview is displayed at the right end, so that the icon F by which a preview display is imaged is displayed at the side of the right end. By displaying such an icon, the user can visually recognize the content assigned to the both ends of the slider. This further improves the usability.

Further, the icon may have a function as an interface of a button. That is, when the icon E of the left end is clicked, the same list view display as when the position of knob of the slider S is moved to the left end may be instructed, and when the icon F of the right end is clicked, the same preview display as when the position of the knob of the slider S is moved to the right end may be instructed. By the combination of the functions, the instruction for list view display or preview display performed by moving the knob which can not be operated by one click can be operated by one click. This further improves the operability.

In the thumbnail view of the embodiment described above, a reduced image which is a target of printing is displayed. However, a reduced image of the top page may be displayed when the target of printing includes a plurality of pages. Further, an icon or the like which representing the print target data may be displayed by an image (for example, an icon or the like showing an application of the creation origin of the print target data).

The slider of the embodiment described above is used as a GUI for switching the views related to information display in the print instructing application 21. However, the slider using the invention can be applied to an application different from print instruction as a matter of course. Further, the assigned instruct content is not limited to the switching of the views and another performance instruction can be assigned.

For example, a slider in which the invention is applied to a photo editing application equipped in a computer can be used. In this case, the instruction for displaying each attribute information (data size, data format, resolution, and the like) of photo data of a target for editing may be assigned as character information at the left end of the slider, the instruction for displaying at the enlargement factor in accordance with the position of the slider may be assigned at the intermediate portion, and the instruction of transition to an edit capable state of the photo data may be assigned at the right end. Herewith, when editing photo data, relevant operations that include recognizing of attribute information of target data, confirmation of visual quality when enlarged or reduced, and transition to editing operation can be performed by one slider. Note that, in the application, a control module similar to the GUI control module 221 of the above embodiment is also equipped in the photo editing application, and the control module instructs performance in accordance with the operated position of each slider.

Further, the slider using the invention may be used for displaying a folder and directory. In this case, the instruction for displaying the detail (name, size, type, update date and hour) of a file in a folder or a folder by character may be assigned to one end of the slider, the instruction for displaying an icon representing the file or folder at the enlargement factor in accordance with the position of the slider may assigned at the intermediate region, and the instruction for displaying an image of the content of the selected file or displaying of an image of the content of the folder of the selected folder in the folder icon may be assigned at the other end.

As described above, in the GUI according to the embodiment and the modification, an instruction of performance different from the above predetermined performance is assigned at the end of the slider type interface by which a state (value) of a predetermined index, for example, enlargement factor, sound amount, or the like which continuously changes is specified to instruct a predetermined performance. Accordingly, relevant plurality of performance instructions, in particular, performance instructions executed by discrete interfaces of a slider and a button can be performed by a sequence of performances by using one slider type interface, so that the operability can be improved.

Further, instructions of tree types of performances can be performed by one interface by assigning different performances for each other at the both ends of the slider type interface.

Further, as described above, an instruction of one predetermined performance in which a continuously changing state (value) is specified is assigned in the intermediate portion except the ends of the slider type interface, so that even when the position of the knob of the slier is not so precise, the performance to be instructed is not changed and the user do not have to pay so much attention to the moving operation of the knob of the slider. Further, moving the knob of the slider to the end at which performance is change is easy, so that it is possible to provide an interface which is easy to operate.

In the embodiment and the application, a different performance instruction is assigned to the both ends of the slider. However a different performance instruction may be assigned to only one end.

Further, the direction of the slider, specifically, the movement direction of the knob is not restricted to right and left and may be moved in the up and down direction or the like. Further, it is not necessary that the knob is moved on a straight line, and may be moved on a circular arc.

The scope of protection of the invention is not limited to the above embodiment, but extends to the invention described in the scope of claims and to inventions equivalent thereto.

What is claimed is:

1. A user interface control program by which a process for controlling a user interface in a computer equipped with a control device and a display device is performed by the control device, the process performed by the user interface control program comprising:
displaying a graphic interface of a slider type for instructing a predetermined performance in which a state of a predetermined index which continuously changes is specified on the display device;
when a position except an end of the graphic interface of the slider type is instructed, instructing the predetermined performance in which a state of the predetermined index corresponding to the instructed position is specified; and
when a position of an end of the graphic interface of the slider type is instructed, instructing a performance different from the predetermined performance.

2. The user interface control program according to claim 1, wherein a performance instructed when a position of one end of the graphic interface is instructed is different from a performance instructed when a position of the other end of the graphic interface is instructed.

3. The user interface control program according to claim 1, wherein an icon for indicating a performance to be instructed when a position of an end is instructed is displayed at the vicinity of the end of the graphic interface.

4. The user interface control program according to claim 3, wherein when the icon is instructed, a performance indicated by the icon is instructed.

5. The user interface control program according to claim 2, wherein the user interface is used for displaying information about a plurality of data on the display device,
when a position except the ends of the graphic interface is instructed, display of images about the plurality of data to which an enlargement factor in accordance with the instructed position is specified is instructed,
when a position one end of the graphic interface is instructed, display of character information related to the plurality of data is instructed, and
when a position of the other end of the graphic interface is instructed, display of an image about predetermined data selected from the plurality of data is instructed.

6. A user interface control method for controlling a user interface in a computer equipped with a control device and a display device, the user interface control method performed by the control device comprising:
displaying a graphic interface of a slider type for instructing a predetermined performance in which a state of a predetermined index which continuously changes is specified on the display device;
when a position except an end of the graphic interface is instructed, instructing the predetermined performance in which a state of the predetermined index corresponding to the instructed position is specified; and
when a position of an end of the graphic interface is instructed, instructing a performance different from the predetermined performance.
